(19) United States
(12) Patent Application Publication
(10) Pub. No.: US 2004/0115010 A1
(43) Pub. Date: Jun. 17, 2004

(54) Apparatus for providing secondary mine roof support

(76) Inventors: Roy Lee Robertson JR., Delbarton, WV (US); James Earl JR., Proctorville, OH (US)

Correspondence Address: ROBERT R. WATERS, ESQ., WATERS LAW OFFICE, PLLC, 633 SEVENTH STREET, HUNTINGTON, WV, 25701, US

(21) Appl. No.: 10/730,653

(22) Filed: Dec. 8, 2003

Related U.S. Application Data
(63) Continuation of application No. 09/944,666, filed on Aug. 31, 2001, now Pat. No. 6,682,268.
(60) Provisional application No. 60/230,244, filed on Sep. 1, 2000.

(51) Int. Cl. E21D 20/00; F16B 43/00

(52) U.S. Cl. 405/259.1; 411/531

(57) ABSTRACT

An improved method and system for providing secondary roof support in a mine is disclosed. The system provides support and containment of rocks that may become loose from the mine roof and comprises a mine roof bolt anchored in a mine roof, a base plate, and a generally flat plate. The base plate and the flat plate each have a hole slightly larger than the standard mine roof bolt diameters to accommodate a mine roof bolt which passes through the base plate, then the flat plate, before continuing on into the mine roof, and which pulls the plates up against the mine roof. The generally flat plate extends laterally out from the bolt in all directions and provides support for the mine roof at locations laterally removed from the roof bolt. The secondary roof support member may also feature one or more stiffening ridges and may exert an upward force on the mine roof at locations laterally removed from the roof bolt.

### CROSS REFERENCE TO RELATED APPLICATIONS

This application is a continuation of U.S. patent application Ser. No. 09/944,666 filed on Aug. 31, 2001 and which in turn claims priority from U.S. provisional application No. 60/230,244, filed on Sep. 1, 2000. This application relates to an apparatus for providing secondary support for roof control in underground mines. The entire disclosures contained in U.S. patent application Ser. No. 09/944,666 and U.S. provisional application No. 60/230,244, including the attachments thereto, are incorporated herein by reference.

### BACKGROUND OF THE INVENTION

In an underground mine, providing and maintaining adequate support for the mine roof is of paramount importance. The majority of serious or fatal accidents occurring in underground mines in the United States over the years have resulted from an inability to control the roof of the mine. While accidents involving major cave-ins of mine roofs have become less prevalent over the years, it is important to note that a fatal accident can occur from the falling of even one large rock from the roof of a mine. Accordingly, mine roof control systems must be completely effective in order to provide safety for personnel working in the mines. The Mine Safety and Health Administration (MSHA) is empowered by the United States government to enforce mine safety standards, including roof support standards, and to provide inspection of mine roof control plans and practices carried out in the mining industry.

As a result of greater emphasis on safety and roof support, serious accidents involving major roof cave-ins have decreased substantially since the 1970s. In order to comply with MSHA standards, underground mines must have a roof control plan in place, and such plan will invariably include provisions for what is known as “primary roof support.” Primary roof support refers to abatement provisions designed to prevent a roof cave-in by effectively sealing and compressing the lowest layers of a mine roof to upper strata of rock. The most common and effective means for attaching lower level rock strata to upper layers is to utilize a roof bolt and epoxy resin to seal the various layers of rock strata. Roof bolts vary in length and size but are typically one-half inch or more in diameter and 30 inches to 12 feet long or longer in overall length. To place a roof bolt in a roof ceiling, a motorized roof bolter, such as that manufactured commercially by such companies as Fletcher Mining Equipment Company, is positioned in the front, unprotected face of the mine and features a drilling mechanism to drill several feet up through the mine roof. After a hole is placed in the roof, an epoxy resin in a pliable plastic tube is inserted in the hole. Next, a roof bolt is placed in the hole, and the placing of the roof bolt tears the packaging for the epoxy resin and mixes said resin to the bolt itself and the surrounding rock layers. The epoxy resin typically “sets up” or hardens within a matter of seconds and the bolt and rock layers are thereby sealed to each other.

In order to place the roof bolt in tension to compress and hold the rock strata, a plate, typically referred to as a “base plate” is placed on the end of the roof bolt. The base plate is typically a steel plate, approximately six (6) inches square, with a hole in the center slightly larger than the diameter of the roof bolt. The roof bolt is inserted into the hole through the hole in the base plate. The end of the roof bolt is threaded such that a nut can be placed upon the of the bolt and tightened to urge the base plate against the mine ceiling, thereby putting the base plate in tension with the bolt which is being held in place by the epoxy resin.

Although the dominant method of providing roof support features the use of an epoxy resin, it is also important to note that many purely mechanical anchor systems have also been developed and utilized over the years. These systems typically feature an anchoring mechanism on the first end of the roof bolt which is caused to embed into the sides of the rock wall at the upper end of the hole after the bolt is inserted. After the first end of the roof bolt is anchored or embedded in the hole, the nut can be tightened on the second end of the bolt, thereby urging the base plate against the mine ceiling and holding the rock strata in compression. Both the mechanical anchoring systems and epoxy based systems are referred to as “primary” roof support systems, and a roof control plan will require and identify the means by which primary roof control is to be achieved.

In most underground mining situations, a roof bolt is placed approximately every four feet in the mine. Accordingly, placement of roof support is a major undertaking and a major source of expense for the mine operator. Despite the cost, roof bolt/epoxy combinations are the most effective and practical means for providing primary roof support, and fully meet the requirements promulgated by MSHA and various state enforcement authorities.

Although methods for providing primary roof support have become increasingly effective over the years, another problem frequently encountered in underground mining is the problem associated with “drawrock.” Drawrock refers to thin layers of shale, one inch to twenty inches thick, which are frequently found in some parts of the United States and around the world immediately adjacent and above seams of coal. In such scenarios, as coal is mined, the the immediate roof material may consist of several inches or feet of shale or drawrock.

Shale is typically very hard in the compressed state, and a mine roof characterized by shale usually is a very stable roof when the mine is first opened and the adjoining seam of coal first removed. However, when shale is exposed to the elements, i.e. moisture, the characteristics of the rock begin to change. Over a period of time, wet shale will begin to deteriorate into drawrock, and the layers of rock will separate. As this occurs, the lower, exposed layers will crumble and begin flaking off and dropping. It is quite typical that the inside of an underground mine will be wet, and often a substantial amount of water will be encountered. Accordingly, drawrock can be a major problem in a wet underground mine which is characterized by a shale roof or upper walls. While primary roof control is quite effective in securing various strata of rock together for three to six foot lengths, primary roof support does not address the problem of drawrock.

In the past, various methods have been utilized by mine operators to control drawrock or other loose material in the immediate roof layer. One method is to use wooden members, referred to as “half-headers” to extend laterally across a portion of a mine opening. Half-headers provide a limited amount of support for drawrock, but are not especially useful because the amount of surface area protected by a half-header is relatively small. In addition, half-headers are bulky and extremely difficult to use. Hauling wooden members into a mine site and locating them at areas where lateral support is needed is extremely expensive and difficult.

Another method for controlling loose material in the immediate roof layer is to use a continuous ribbon system, which has been commercialized since at least the 1970s. In essence, this method involves a steel ribbon six or more inches wide held against the roof by means of the roof bolt used for primary support. In theory, the ribbon serves to attach each roof bolt in a particular line and hold any loose material located between the roof bolts. However, this system features a number of significant drawbacks, including the fact that such steel ribbons are extremely difficult and costly to install. Furthermore, since the ribbon is straight, it is only possible to utilize such method between a series of roof bolts if, in fact, the roof bolts are reasonably well aligned in a straight line with respect to each other. To the extent that some roof bolts are not exactly spaced in line with the previous bolt four foot earlier, the ribbon will not fit. Furthermore, the usefulness of this method is compromised when the surface of the mine roof is not uniform. If, as is usually the case, the mine roof is characterized by pits or sudden changes in lateral height, the ribbon may not, in fact, be resting against said roof. As a result, the ribbon is not providing protection against loose drawrock in such areas. In addition, even when installed properly, the ribbon does not provide upward pressure to the drawrock to prevent it from beginning to separate.

Another method occasionally utilized in an underground mine is the use of a screen assembly mounted against the mine roof, such as to restrain and collect drawrock or other material that becomes loose. The screens typically feature a two-inch by two-inch grid, somewhat similar to a chain link fence, and is attached to the mine roof by means of the roof bolts used for primary support and/or other attachment devices and bolts. Screen assemblies are very effective at controlling drawrock, but pose the distinct disadvantage of being very expensive and difficult to install. Essentially, an installation of a screen is analogous to the installation of a permanent steel roof throughout a mineshaft and the expensive nature of that undertaking can easily be the difference between a profitable mine and a mine which the owner cannot afford to operate. Moreover, when such a screen is in place, once enough rock falls on top of the screen, it begins to sag from the weight, creating a new hazard.

### SUMMARY OF THE INVENTION

The objective of this invention is to provide an effective device for providing secondary roof support in an underground mine such as to reduce the hazards of localized crumbling or deterioration of a mine roof. In order to attain this objective, the present invention generally comprises a steel plate which may be flat or slightly concave, a standard primary roof bolt, and a methodology for arranging said elements to provide secondary mine roof support. By applying an upward pressure on the roof and effecting a larger coverage area for each roof bolt, the opportunity for drawrock separation to begin is reduced.

Another primary objective of the present invention is to provide a secondary mine roof support system that is durable enough to withstand physical pressure as well as environmental challenges such as moisture, including acidic moisture, dust, and heavy equipment access.

Yet another objective of this invention is to create a device for secondary mine roof support which is inexpensive to manufacture, inexpensive to install, and increases the life expectancy of secondary mine support members. In addition, a further objective of the invention is to create a secondary mine support system that does not require frequent maintenance or replacement of component parts. Specifically, it is desired that the apparatus disclosed in this invention should have a life expectancy in excess of fifteen years.

Another objective of this invention is to provide a device that protects the integrity of the primary roof support system. Once drawrock falls from around the base plate, this area of the mine has a much reduced primary roof support. The present invention, by creating a greater contact area, helps minimize that hazard.

Another primary objective of the present invention is to provide an apparatus for secondary mine roof support that is easy to transport into location in the mine. Accordingly, this invention serves to reduce both the cost and personnel difficulty involved in transporting the device, such as to increase the likelihood that the device will be used by mine employees.

As discussed above, the method and device of the present invention overcomes the disadvantages inherent in prior art methods and devices. In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Accordingly, those skilled in the art will appreciate that the conception upon which this invention is based may readily be utilized as a basis for the design of other structures, methods, and systems for carrying out the several purposes of the present invention. It is important, therefore, that the claims be regarded as including such equivalent constructions insofar as they do not depart from the spirit of the present invention.

Furthermore, the purpose of the foregoing Abstract is to enable the U.S. Patent and Trademark Office and the public generally, and especially including the practitioners in the art who are not familiar with patent or legal terms or phraseology, to determine quickly from a cursory inspection, the nature and essence of the technical disclosure of the application. The Abstract is neither intended to define the invention of the application, nor is it intended to be limiting to the scope of the invention in any way.

### BRIEF DESCRIPTION OF THE DRAWINGS

Additional utility and features of this invention will become more fully apparent to those skilled in the art by reference to the following drawings, wherein all components are designated by like numerals and described more specifically:

FIG. 1 is a plan view from the bottom, of the preferred embodiment of the secondary mine roof support member constructed in accordance with this invention.

FIG. 2 is a side view of the preferred embodiment of the secondary mine roof support member constructed in accordance with this invention.

FIG. 3 is an exploded side view showing the system for providing secondary mine roof support used in an epoxy-based roof anchoring system.

### DETAILED DESCRIPTION OF THE INVENTION

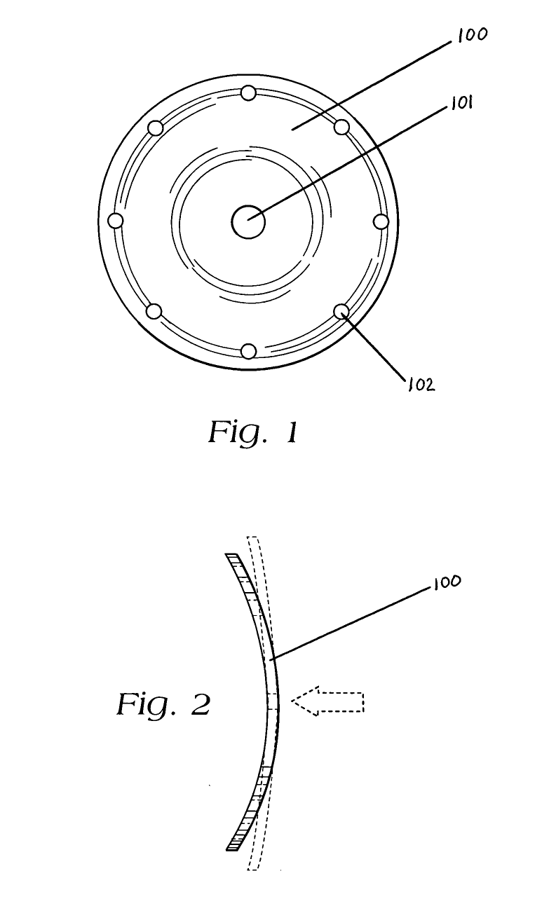

FIG. 1 shows the secondary mine roof support member 100 of the present invention. The support member 100 is a one-piece design and can be constructed from a variety of materials, but is optimally constructed of 20 gauge cold rolled steel. As indicated in the drawing, the preferred embodiment is 19.5 inches in diameter, although other sizes are certainly possible.

Support member 100 is also characterized by an aperture 101 in the center of support member 100. Aperture 101 is preferably a three-quarter inch diameter aperture such as to accommodate the two most prevalent sizes of primary roof support bolts: three-quarter inch, and five-eighths inch. The preferred embodiment may also included one or more weep holes 102 arranged along the periphery of the member, at approximately one inch from the edge, although they are not required. Weep holes 102 allow for moisture that collects from the enclosed roof area to be exhausted such that it does not build up such as to support rusting of the unit.

FIG. 2 shows a side view of the preferred embodiment shown in FIG. 1. This diagram essentially shows the center deflection of support member 100 such that it is “bowed inward”. In practice, this feature provides a measure of upward support or pressure by the support member such as to assist the primary roof support system in keeping the various rock strata tightly secured in the area of the roof bolt. The amount of upward support can be varied as a function of the grade and thickness of the support member as well as the degree of center deflection. As shown in FIG. 2, the optimum center deflection for the preferred embodiment can vary according to mine requirements or design preferences

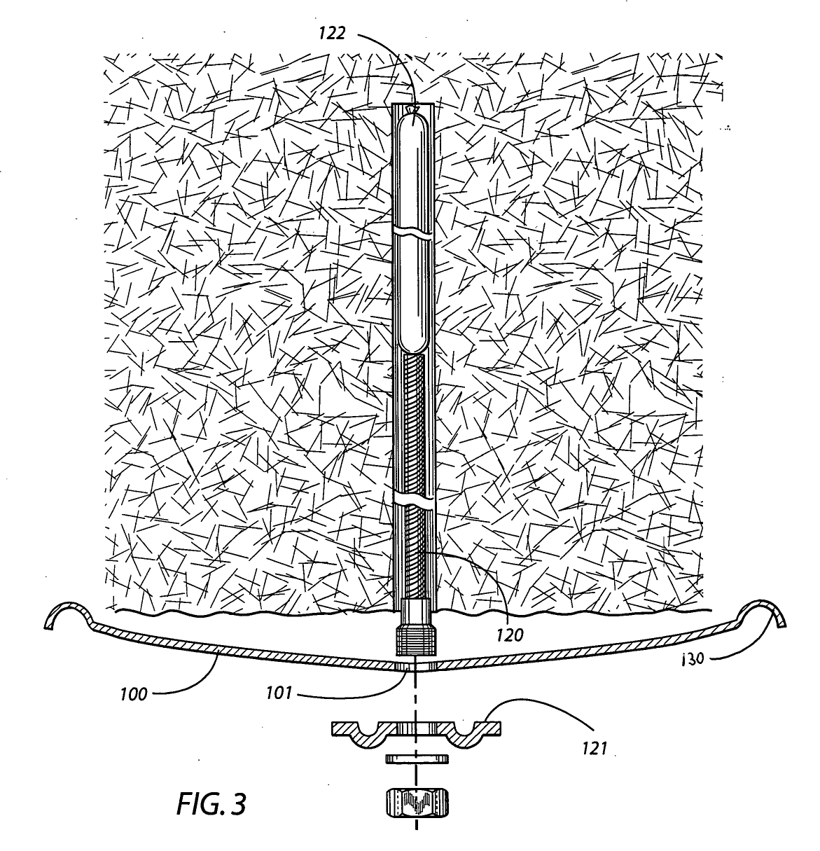

FIG. 3 shows an exploded view of the system for providing secondary roof support in an underground mine. As shown, a hole has been drilled in the strata above the mine roof and a tube of an epoxy-based anchoring adhesive 122 has been placed into the hole. In general, the epoxy-based adhesive 122 will consist of a plastic tube containing two components which are separated from each other within the tube (not shown). The epoxy will not harden unless the tube is punctured and the two materials are mixed together. Of course, other types of adhesive components could also be used and not detract from the purposes of the current invention, and as noted earlier, the device for providing secondary roof protection disclosed herein may be used with purely mechanical roof support systems.

As further shown in FIG. 3, a roof bolt 120 is placed into the mine roof hole and is rotated by a mechanical drilling device. The placement and rotation of roof bolt 120 in the hole serves to puncture epoxy tube 122 and mix the contents of the tube with the bolt and the adjacent rock strata. Upon the open end of roof bolt 120, secondary support plate 100 is placed. Next, base plate 121 is placed upon the end of the roof bolt, and finally, the end of the roof bolt is secured by a nut or a nut and washer combination.

The preferred embodiment of the secondary support plate includes one or more stiffening ridges, 130 which provide additional strength and may provide a contact location for the application of upward pressure at a location laterally removed from the central anchoring of the base plate 121. As shown in FIG. 3, a stiffening ridge 130 may be located on the outer perimeter of plate 100. Although a stiffening ridge 130 may be helpful, it is not required. Furthermore, depending on the particulars of the mine roof, plate 100 may include multiple stiffening ridges.

FIG. 3 shows a construction of the secondary roof support plate wherein the plate is slightly convex or bowed. This construction is useful to provide additional upward force at the point of contact for the stiffening ridge 130. However, plate 100 may also be constructed as a flat plate. In addition, although a round construction for support plate 100 may be particularly useful, it should also be understood that other shapes and sizes may be used including square and rectangular plates.

We claim:

1. A mine roof bolting system for providing secondary support to the roof of an underground mine comprising:
a) a roof bolt anchored in a pre-drilled hole in the roof of said mine;
b) a base plate with an aperture slightly larger than the diameter of said roof bolt located at the end of said roof bolt such that said mine roof is held in tension by said base plate and said roof bolt;
c) a generally flat plate member with an aperture at or near the center of said plate member, said aperture being slightly larger than the diameter of said roof bolt wherein said plate member is placed immediately against the roof of said mine between said base plate and the mine roof such that said roof bolt extends through said base plate and said plate member, and into said pre-drilled hole in said mine roof;
d) wherein said plate member extends laterally in all directions from said roof bolt and provides support for the mine roof at a location laterally removed from the location of said base plate when said roof bolt and base plate are under tension.

2. The mine roof bolting system of claim 1 wherein upon assembly of said plate member, base plate and roof bolt, said plate member applies an upward force against at least a portion of said mine roof laterally removed from said base plate.

3. The mine roof bolting system of claim 1 wherein said plate member is constructed of steel.

4. The mine roof bolting system of claim 1 wherein said plate member is round.

5. The mine roof bolting system of claim 1 wherein said plate member includes one or more stiffening ridges laterally removed from said aperture.

6. The mine roof bolting system of claim 5 wherein said plate includes a stiffening ridge located near the outer perimeter of said plate.

7. The mine roof bolting system of claim 1 wherein said plate member is slightly convex or bowed with respect to the mine roof.

8. The mine roof bolting system of claim 7 oriented such that when said plate member is held in tension by said base plate and roof bolt, an upward force is applied at the outer edge of said plate member to overcome the convex orientation of the plate member.

9. A device for providing secondary support in an underground mine in conjunction with a conventional roof bolt support system comprised of a base plate held in tension against the roof of said mine by a roof bolt anchored in a pre-drilled hole, said device comprising:
a) a generally flat plate member with an aperture at or near the center of said plate member, said aperture being slightly larger than said roof bolt;
b) said plate member located immediately against the roof of said mine between said base plate and the mine roof such that said roof bolt extends through said base plate and said plate member, and into said pre-drilled hole in said mine roof;
b) said plate member extending laterally in all directions from said roof bolt and
c) said plate member providing support for said mine roof at a location laterally removed from the location of said base plate.

10. The device of claim 9 wherein upon assembly of said plate member, base plate and roof bolt, said plate member applies an upward force against at least a portion of said mine roof laterally removed from said base plate.

11. The device of claim 9 wherein said plate member is constructed of steel.

12. The device of claim 9 wherein said plate member is round.

13. The device of claim 9 wherein said plate member includes one or more stiffening ridges laterally removed from said aperture.

14. The device of claim 13 wherein said plate includes a stiffening ridge located near the outer perimeter of said plate.

15. The device of claim 9 wherein said plate member is slightly convex with respect to the mine roof such that when said plate member is held in tension by said base plate and roof bolt, an upward force is applied at the outer edge of said plate member to overcome the convex orientation of the plate member.

16. A method for providing primary and secondary roof support in an underground mine, comprising the steps of:
a.) drilling a hole through a roof of the underground mine and into upper level rock strata;
b.) positioning a lateral support member with a central aperture adjacent the roof of said underground mine centered over said hole, said lateral support member providing support for rock strata at a location laterally removed from said hole;
c.) positioning a base plate featuring a central aperture adjacent said lateral support member; and
d.) inserting a roof bolt through said central apertures of said base plate and said lateral support member into said hole, and anchoring said roof bolt by an adhesive or compressive means to secure and support the roof of said underground mine.

17. The method of claim 16, wherein said support member features a center deflection with respect to the radial edge of said support member such that said support member is slightly convex with respect to the mine roof surface.

18. The method of claim 16 wherein said support member features one or more stiffening ridges laterally removed from the center of said support member.

19. The method of claim 16 wherein said support member applies an upward force on the roof of the mine at a location laterally removed from the center of said support member.
